(19) United States
(12) Patent Application Publication
(10) Pub. No.: US 2025/0091842 A1
(43) Pub. Date: Mar. 20, 2025

(54) MOBILE HYDRAULIC WORKING MACHINE COMPRISING EMERGENCY STOP VALVES, AND METHOD FOR CONTROLLING A MOBILE HYDRAULIC WORKING MACHINE

(71) Applicant: OILFIX GMBH, Köln (DE)

(72) Inventor: Berthold WINZ, Köln (DE)

(21) Appl. No.: 18/966,116

(22) Filed: Dec. 2, 2024

Related U.S. Application Data
(63) Continuation of application No. PCT/EP2023/059200, filed on Apr. 6, 2023.

(30) Foreign Application Priority Data
Jun. 3, 2022 (DE) 10 2022 114 096.2

(51) Int. Cl. B66C 13/14; B66C 13/18; B66C 23/00; B66C 23/42; B66C 23/90; F15B 13/04

(52) U.S. Cl. CPC B66C 13/14; B66C 13/18; B66C 23/42; B66C 23/54; B66C 23/905; F15B 13/0401; B66C 2700/0371

(57) ABSTRACT

A mobile hydraulic working machine includes an upper structure, a lower structure, a boom assembly with an arm, an attachment connected to the arm and a hydraulic system to move the boom assembly and the attachment. The hydraulic system includes at least one hydraulic pump and a valve block to regulate flow through at least one hydraulic line connecting a hydraulic consumer to the at least one hydraulic pump in order to actuate the hydraulic consumer. The at least one hydraulic line includes an emergency stop valve operable to close the hydraulic line in an emergency and located in the hydraulic line in a region of the boom assembly and/or in the upper structure on a flow side of the valve block remote from the at least one hydraulic pump.

### CROSS REFERENCE TO RELATED APPLICATIONS

This application is a continuation application of International Application No. PCT/EP2023/059200, filed on Apr. 6, 2023, which claims the benefit of priority to German Patent Application No. 102022114096.2, filed on Jun. 3, 2022. The entire contents of each of these applications are hereby incorporated herein by reference.

### BACKGROUND OF THE INVENTION

### 1. Field of the Invention

The present invention relates to mobile hydraulic working machines and to methods for controlling mobile hydraulic working machines.

### 2. Description of the Related Art

Mobile hydraulic work machines, especially construction machines, are used in a variety of ways on construction sites for demolition and dismantling work. Such mobile machines are also used in civil engineering and forestry. Examples of mobile machinery include cranes, excavators, as well as material handlers, forestry machines and the like. In the demolition sector, so-called “longfront” excavators or demolition excavators are used. The long booms and arms make mobile hydraulic construction machinery a good tool for using hydraulic attachments for the respective purpose, even at heights of over 20 m. When operating mobile hydraulic construction machines, the hydraulic hoses, which form the hydraulic system of the attachments, are exposed to external influences due to ageing processes or the weather, which can cause damage to the hydraulic hoses. However, other and much more unpredictable sources of damage are external mechanical effects on the hydraulic hoses caused by working in areas that are not completely visible. The excavator's operating personnel cannot see every part of the mobile hydraulic construction machine's arm during operation, which means that hydraulic hoses can get caught on sharp objects on the construction site, for example, or be punctured, cut or crushed and thus damaged. Due to unavoidable ageing processes on the one hand and unforeseeable external influences on the other, oil leakages may occur in the hydraulic hoses during regular operation of the construction machine. It is known from EP 25 47 912, among others, to interrupt lines of the hydraulic system on the attachment that are damaged by pipe ruptures so that the attachment does not perform any uncontrolled movements, remains in a fixed position and does not pose any safety risks on the construction site. However, the hydraulic system is only interrupted on the side of the attachment, which is critical, as the long booms and arms of mobile hydraulic construction machines also require long hydraulic lines that have to be routed to the end of the arm to the attachment, so that in the event of an oil leakage, over 400 liters of oil can often escape in less than half a minute and hit the ground on the construction site. The loss of oil not only means additional costs due to the replacement of the lost oil, but also considerable environmental pollution of the construction site.

The same applies to the use of harvesters in forestry, some of which carry grapples on long booms for gripping tree trunks, which, in addition to the hydraulic unit for the grapple, are also equipped with a hydraulic motor for rotating the grapple.

### SUMMARY OF THE INVENTION

Example embodiments of the present invention provide cost-saving and environmentally friendly mobile hydraulic working machines and methods for controlling such working machines.

An example embodiment of a mobile hydraulic working machine, in particular a construction machine, includes an upper structure, a lower structure, a boom assembly, preferably with a boom (optionally with an intermediate boom) and with an arm, an attachment connected to the arm and a hydraulic system to move the boom assembly and the attachment. The hydraulic system includes at least one pump and one valve block. The valve block is structured to regulate the oil flow of at least one, preferably at least two, hydraulic line(s) connecting the hydraulic consumer, in particular the attachment, to the pump in order to control a hydraulic consumer, in particular the attachment. At least one emergency stop valve is assigned to the hydraulic line or lines, which is operable to close the hydraulic line in an emergency, and the at least one emergency stop valve is in a region of the boom assembly in the hydraulic line and/or in the upper structure on the flow side of the valve block remote from the pump.

The at least one emergency stop valve makes it possible to close the hydraulic line(s) in the event of a leakage to reduce or prevent hydraulic oil from escaping. Emergency stop valves can also include shut-off devices such as gate valves or ball valves. It is particularly easy to retrofit the emergency stop valves in the upper structure area. The use of emergency stop valves in the area of the arm is advantageous, as this is of great benefit in the event of leakage in the area between the boom assembly and the attachment. If the hydraulic consumer is a single-acting hydraulic cylinder, for example, only one hydraulic line can be provided, which includes an emergency stop valve. In the event that the hydraulic consumer is a double-acting hydraulic cylinder, two hydraulic lines are provided which are connected to the valve block and each include at least one emergency stop valve. If the hydraulic consumer is the attachment, the valve block can be an additional valve block with a volume control valve that controls the volume flow to the attachment.

Preferably, the at least one, in particular at least two hydraulic line(s), is/are located in a protected area on an upper side of the arm or are defined by channels, and the emergency stop valve is located in the protected area. A protected area indicates that the hydraulic line is a rigid tube, in particular made of metal, which is protected from external influences. These protected areas are distinguished from areas of the hydraulic line with flexible hoses, which can quickly tear or be damaged.

The hydraulic line is preferably attached to the hydraulic consumer, in particular the attachment, at a first attachment point and to the boom assembly, in particular the arm, at a second attachment point and defines a flexible hose bend between the two attachment points such that the at least one emergency stop valve is preferably outside the flexible hose bend in the area of the boom assembly or the arm. During regular work with the mobile hydraulic construction machine, oil often leaks from the flexible hose bends, as their nature makes them susceptible to getting stuck at points on the construction site, for example. However, the hose bends are important for the use of the working machine, in particular, the construction machine, as without the hose bends, no large movements of the boom assembly and the attachments would be possible. Closing at least one emergency stop valve and thus the hydraulic lines and the hydraulic system prevents oil from escaping further in the event of a leakage.

Preferably, the emergency stop valve is an electronically controlled solenoid valve, which is particularly cost-effective. The emergency stop valves can be 2-way valves and the hydraulic system includes at least one return line that connects the emergency stop valves to a hydraulic oil tank from which the hydraulic system is fed by the pump. In this case, it is not necessary to communicate with the valve block, as the hydraulic oil flow through the hydraulic lines in the area of the valve block does not have to be interrupted.

In a further example embodiment, the mobile hydraulic working machine, in particular construction machine, includes an emergency stop actuator which communicates with the at least one emergency stop valve and/or optionally additionally with the valve block and is set up to close the at least one emergency stop valve when actuated.

Preferably, the emergency stop actuator is arranged in a driver's cab of the mobile hydraulic machine. If the driver of the mobile hydraulic construction machine detects a leakage, he can actuate the emergency stop device and thus prevent the hydraulic oil from continuing to escape at the point of breakage.

Preferably, at least one sensor is assigned to the at least one hydraulic line to detect a leakage in the at least one hydraulic line, and the at least one sensor communicates with the emergency stop valves and/or the valve block. In this case, the emergency stop valves can be closed automatically in the event of a leakage and pressure drop in the hydraulic line.

In an example embodiment, the mobile hydraulic working machine is a construction machine, in particular a long-boom excavator, which has a reach height in a range from about 15 m to about 90 m and in particular, a weight class between about 25 t and about 400 t, for example.

Furthermore, an example embodiment of a method for controlling a mobile hydraulic working machine, in particular a construction machine, including an upper structure, a lower structure, a boom assembly with an arm, an attachment connected to the arm and a hydraulic system to move the boom assembly and the attachment, is provided, wherein the hydraulic system includes at least one pump and a valve block, in particular an additional valve block, and at least one, in particular at least two, hydraulic line(s) connecting the attachment to the pump, wherein the valve block is connected to the hydraulic line(s). The method includes detecting a leakage in a hydraulic line(s) between a hydraulic consumer, in particular the attachment and the valve block, switching or actuating and/or moving at least one emergency stop valve in a region of the boom assembly and/or in the upper structure on a flow side of the valve block remote from the pump in (one of) the hydraulic line(s) to shut off the at least one hydraulic line, in particular at least two hydraulic lines.

It is preferable to ensure that the shut-off position is maintained until the leakage has been rectified. After the leakage has been rectified, it is advantageous if the emergency stop valve is returned to the initial state before the leakage or to an initial position.

In contrast to other valves or valve arrangements that close hydraulic lines, this method allows the mobile machine to continue to be operated and moved, except for the controller associated with the leakage line. The method can be used to prevent large quantities of hydraulic oil from escaping from a leakage. Since it is ensured or can be ensured that the shut-off position is maintained until the leakage has been rectified and the hydraulic line has been repaired, hydraulic oil can be reliably prevented from escaping from the hydraulic line. The transfer of the emergency stop valve to a state as it was before the leakage and the shut-off of the line is preferably carried out without tools and without replacing or renewing parts/components of the emergency stop valve. It is particularly preferable for the initial state to be brought about automatically after, for example, approval by an operator. Such an approval can include an input in an operation interface, actuation of a switch (emergency shut-off switch or emergency stop switch) or the like.

Preferably, the at least one emergency stop valve is a 2-way valve and the hydraulic system includes at least one return line and the method further includes connecting the hydraulic line to the return line by the emergency stop valve, such that the return line is connected to a hydraulic oil tank from which the hydraulic system is fed by the pump.

Preferably, the method includes actuating the valve block, in particular the additional valve block, to shut off the at least one (two) hydraulic line(s), after a predetermined time delay.

Preferably, the method includes detection by sighting by an operator or by a sensor in the hydraulic line.

Preferably, the mobile hydraulic construction machine includes an emergency stop actuator communicating with the emergency stop valves and/or the additional valve block and the method includes manually actuating the emergency stop device.

The mobile hydraulic construction machine can be structured as described above.

Example embodiments of the present invention are explained in more detail below with reference to the drawings. Identical or functionally identical components are provided with the same reference signs in the figures.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 shows a spatial representation of a mobile hydraulic construction machine according to an example embodiment of the present disclosure.

FIG. 2 shows a top view of the mobile hydraulic construction machine from FIG. 1.

FIG. 3 shows a schematic representation of an example embodiment of a hydraulic system of an attachment of the mobile hydraulic construction machine from FIG. 1.

FIG. 4 shows a schematic representation of a further example embodiment of a hydraulic system of an attachment according to the present disclosure.

### DETAILED DESCRIPTION OF THE EXAMPLE EMBODIMENTS

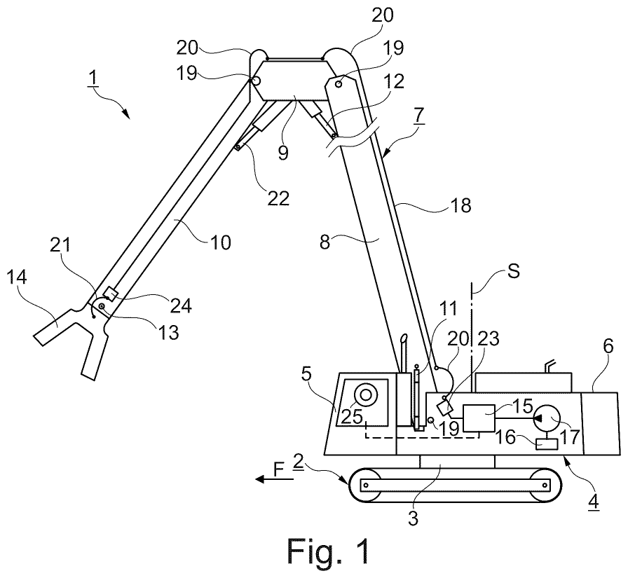

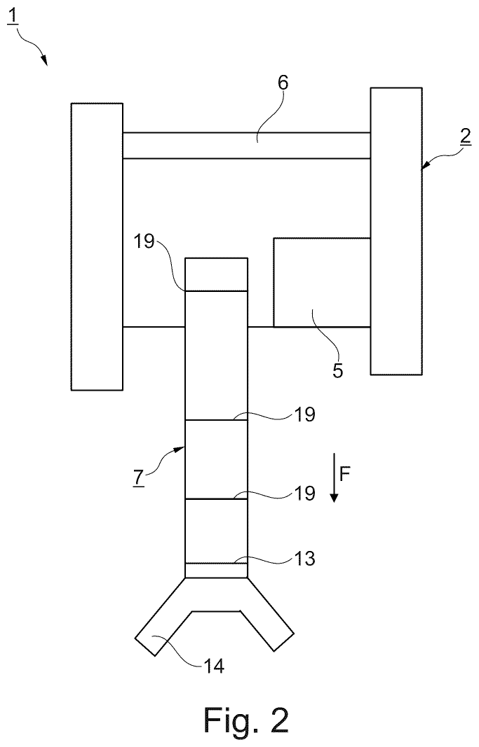

FIG. 1 shows a mobile hydraulic construction machine 1 according to an example embodiment of the present invention as a long-arm boom excavator with a lower structure 2, which is connected to an upper structure 4 via a slewing mechanism 3 that can rotate about a slewing axis S. The slewing mechanism 3 enables a controlled slewing movement between the upper structure 4 and the lower structure 2 about the slewing axis S. In general, a distinction can be made between mobile excavators and crawler excavators. On the one hand, the lower structure 2 can have tires in a chassis and is referred to as a mobile excavator, whereby mobile excavators are only used in the weight class up to 25 t, and on the other hand the lower structure 2 can have tracks, so that crawler excavators are referred to, which are used in all weight classes. Mobile and crawler excavators are to be distinguished as self-propelled land vehicles from other types of excavators such as floating excavators. In the present example embodiment, the long arm excavator 1 is realized as a crawler excavator, which is in a weight class between about 25 t and about 400 t typical for demolition work, for example. The upper structure 4 includes a driver's cab 5 at its end in the direction of travel F (straight ahead) and a counterweight 6 opposite the driver's cab 5. FIGS. 1 and 2 show a three-part boom assembly 7, which is attached to the upper structure 4 next to or behind the driver's cab 5. The boom assembly 7 includes three links 8, 9, 10 arranged one behind the other. A first portion 8, called the boom, a second portion 9, called the intermediate boom, and a third portion furthest from the upper structure, called the arm 10, whereby two consecutive members are pivotably mounted to each other by bolts, for example. The boom assembly 7 further comprises a boom cylinder 11, which can move the first link 8, and an intermediate boom cylinder 12, which can move the second link 9 of the boom assembly 7. Furthermore, an arm cylinder 22 is provided which can be driven to move the arm 10. An attachment 14 is attached to the free end of the arm 10, through which an arm head bolt 13 passes. This connection can preferably be made by a quick coupler, for example. The attachment 14 and the quick coupler can also be pivoted about the pivot axis defined by the arm head bolt 13. In this example embodiment, the attachment 14 is a gripping tool, but all hydraulic attachments such as shears can be used.

The mobile hydraulic construction machine 1 includes a hydraulic system that drives the boom cylinder 11 and the intermediate boom cylinder 12 as well as the arm cylinder 22 by using hydraulic oil. The hydraulic oil flow and the associated movements are preferably controlled and monitored by a main valve block of the hydraulic system, not shown, located in the upper structure 4. The main valve block includes valves that regulate a supply quantity of hydraulic oil to one of the hydraulic cylinders. Furthermore, the main valve block is operable to control a hydraulic slewing drive of the slewing mechanism 3 and a hydraulic travel drive for the tracks of the lower structure 2. An additional valve block 15, a hydraulic oil tank 16 and a hydraulic pump 17 also belong to the hydraulic system are located in the upper structure 4. The hydraulic pump 17 supplies the hydraulic oil of the hydraulic system and is connected to the main valve block and the additional valve block 15 via a hydraulic connection. Several pumps can be used in the hydraulic system if the performance of one pump is not sufficient for the required application or if the system is to be designed redundantly. The additional valve block 15 controls and regulates a hydraulic oil flow to the attachment 14. Hydraulic lines 18 lead from the additional valve block 15 to the attachment 14. FIG. 1 shows only one hydraulic line 18, but depending on the attachment used and the type of construction machine, there may be several or at least two hydraulic lines 18. The type of attachment 14 and the movement that it can perform define the number of hydraulic lines 18 (used and connected). The hydraulic line 18 is provided in the area of bolt 19 of the boom assembly 7, between the upper structure 4 and the first link 8, and between the first link 8 and the second link 9 and between the second link 9 and the arm 10, by flexible hose lines arranged in a bend, also called boom hose bends 20. A flexible hose bend 21 is also preferably provided between a first attachment point on the attachment 14 and a second attachment point on the handle 10. The flexible boom hose bends 20 and the flexible hose bend 21 make it possible for the individual links of the boom assembly 7 to pivot about the longitudinal axis of the bolt 19 without the hydraulic line 18 being interrupted or ruptured. The hose bend 21 and the boom hose bends 20 are provided for each additional hydraulic line 18 (not shown). The portions of the hydraulic line 18 that extend centrally along the links of the boom assembly 7 away from the swivel axles or the bolt 19 are preferably rigid metal tubes. The ends of the metal tubes are each connected to a flexible hose line to define the hydraulic line 18. The metal tubes provide a protected area in which the hydraulic line 18 is protected from external damage. In the hydraulic line 18 shown, there are two emergency stop valves 23, 24 between the additional valve block 15 and the attachment 14. The emergency stop valves 23, 24 of the at least two hydraulic lines 18 are divided into first emergency stop valves 23 and second emergency stop valves 24 and are shown schematically as a rectangle in FIG. 1. The first emergency stop valve 23 and the second emergency stop valve 24 can close the corresponding hydraulic line 18 at the respective position. This can ensure that the emergency stop valve 23, 24 located on the side near the additional valve block of an occurring oil leakage reduces or prevents the hydraulic oil located between this emergency stop valve 23, 24 and the hydraulic pump 17 or the hydraulic oil tank 16 in the hydraulic lines 18 from escaping. The first emergency stop valve 23 is located in the upper structure 4 on the flow side of the additional valve block 15 remote from the pump. The second emergency stop valve 24 is located in the hydraulic line 18 in the area of the arm 10 outside the hose bend 21. A position that is directly upstream or downstream of the flexible hose line in the area of the arm head bolt 13 in the direction of flow is particularly preferred, as shown in FIG. 1. Experience has shown that the hose lines often leak in the area of the arm head bolt 13. The position of the second emergency stop valve 24 described above makes it possible to maintain the maximum possible amount of hydraulic oil in the hydraulic lines 18 in the event of such a leakage. If an oil leakage occurs in the hose bend 21, closing the second emergency stop valve 24 allows the oil in the hydraulic line 18 between the second emergency stop valve 24 and additional valve block 15 to remain in the hydraulic lines 18 and prevents it from escaping. It is conceivable to use further emergency stop valves which, for example, protect the boom hose bends 20 of the second link 9 against leakage. At least one emergency stop valve 23, 24 is required per hydraulic line 18. Even the first emergency stop valve 23 prevents the majority of the hydraulic oil from escaping in the event of a leakage in the flexible hose line in the area of the arm head bolt 13. The emergency stop valves 23, 24 differ from conventional pipe rupture safety devices, which are now installed as standard in mobile hydraulic construction machines. The pipe rupture safety valves, which are not shown, are installed on the attachment 14 and prevent uncontrolled movements of the attachment 14 in the event of pipe ruptures in order to protect operating personnel and construction site personnel. They maintain the pressure of the hydraulic oil in the attachment 14 or the working chambers of the hydraulic cylinders installed in it and allow the attachment 14 to remain in a fixed position. The emergency stop valves 23, 24 interrupt the hydraulic system at at least one point towards the additional valve block 15. The hydraulic oil in the hydraulic line between the break point and the emergency stop valve 23, 24 escapes. However, the emergency stop valve 23,24 prevents large quantities of hydraulic oil from escaping and thus contributes to environmental protection during demolition work. The emergency stop valves can also be provided in hydraulic lines connected to other hydraulic consumers. The hydraulic consumer can, for example, be the boom cylinder 11, the intermediate boom cylinder 12 and/or the arm cylinder.

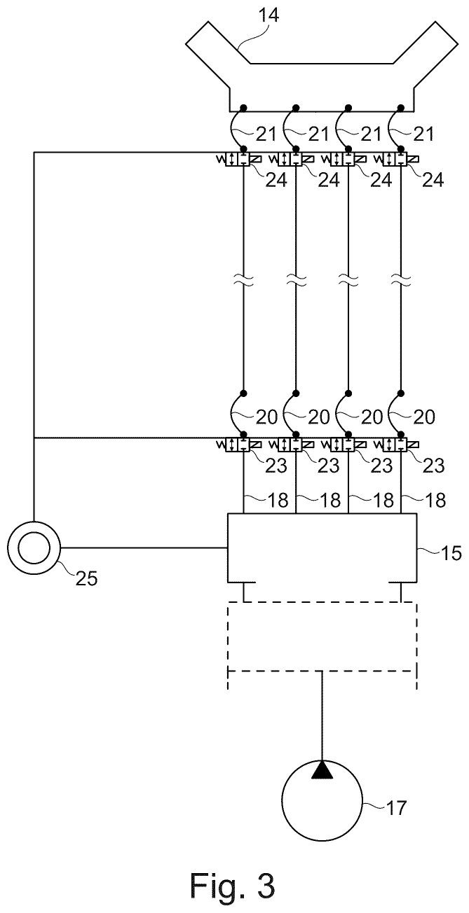

FIG. 3 shows a portion of a hydraulic system, which is only shown schematically and is used to control the movement of the attachment 14. The hydraulic valves of the additional valve block 15 are electrically pilot-controlled to move the attachment 14, which is not shown in the figure. The hydraulic pump 17 supplies the additional valve block 15 with the oil pressure required to control the attachment 14 or its hydraulic cylinder. The additional valve block 15 regulates the volume flow of the hydraulic oil through the four hydraulic lines 18 shown as an example and can therefore control the movement of the attachment 14. There is a first emergency stop valve 23 and a second emergency stop valve 24 per hydraulic line 18. The first emergency stop valves 23 and the second emergency stop valves 24 are each located in two different sections of the hydraulic line 18. The hose bends 20 closest to the additional valve block and the flexible hose bends 21 in the area of the arm head bolt 13 are shown.

On the one hand, the first emergency stop valves 23 are arranged in the upper structure 4, in an upper structure section of the respective hydraulic line 18, which is located on the flow side of the additional valve block 15 remote from the pump, and on the other hand, the second emergency stop valves 24 are arranged in a boom assembly section of the respective hydraulic line 18, which is located outside the upper structure 4 and in the area of the arm 10 outside the flexible hose bends 21, as already described above. The emergency stop valves 23, 24 are open during regular operation of the mobile hydraulic construction machine 1 so that the hydraulic oil can flow unhindered through the emergency stop valves 23, 24. The emergency stop valves 23, 24 are controlled by an emergency stop actuator 25. When the emergency stop actuator 25 is actuated, the hydraulic lines 18 are closed by the emergency stop valves 23, 24 and the hydraulic oil flow is stopped. The emergency stop device 25 communicates electronically with the additional valve block 15 and switches the emergency stop valves 23, 24.

After a leakage has been detected in one of the hydraulic lines 18 between the attachment 14 and the additional valve block 15, the emergency stop valves 23, 24 are switched and the hydraulic lines 18 are shut off. FIG. 3 shows the closed state of the emergency stop valves 23, 24, which is achieved by actuating the emergency stop actuator 25.

In an example embodiment, the emergency stop valves 23,24 are electronically controlled solenoid valves.

In an example embodiment, the leakage is detected by the operating personnel and the operating personnel then actuates the emergency stop actuator 25 and the emergency stop valves 23, 24 are switched and shut off the hydraulic lines 18. The detection can also be carried out by a sensor which is assigned to the hydraulic lines 18 and the emergency stop actuator 25 can then be actuated automatically.

In an example embodiment, the additional valve block 15 is first actuated by the emergency stop actuator 25 and the additional valve block 15 shuts off the at least two hydraulic lines 18. The emergency stop valves 23, 24 are then switched and the hydraulic lines 18 are closed with a predeterminable time delay.

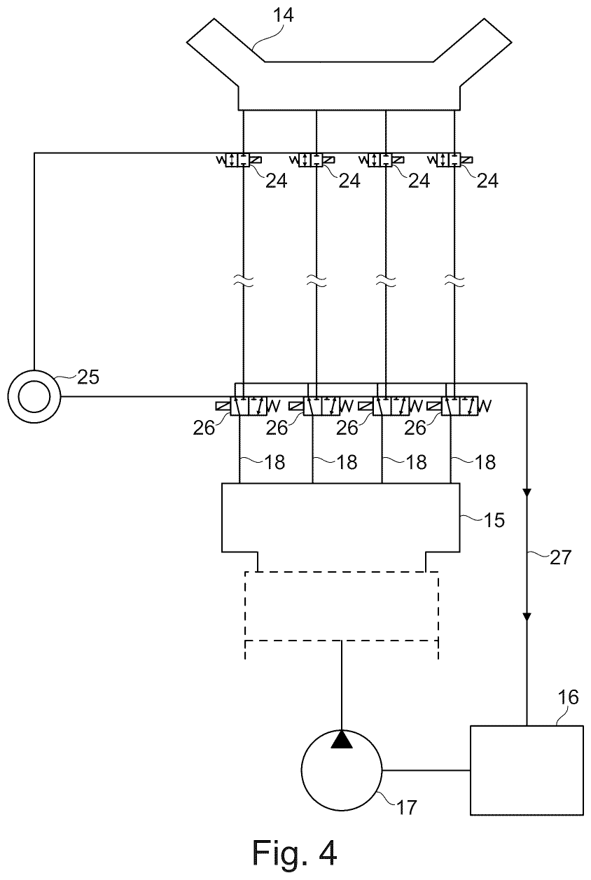

FIG. 4 shows a further example embodiment of a portion of the hydraulic system largely analogous to FIG. 3. In this case, the attachment 14 is hydraulically pilot-controlled by a low-pressure line. The boom hose bends 20 and the hose bends 21 have not been shown. The differences are explained below. In the example embodiment shown in FIG. 4, the first emergency stop valves 23 in the upper structure section of the hydraulic lines 18 are realized by 2-way valves 26, which can be connected to the hydraulic oil tank 16 of the hydraulic system via a return line 27. In regular operation, the second emergency stop valves 24, which in one example embodiment are electronically controlled solenoid valves, are open in the boom assembly section and the 2-way valves 26 in the upper structure section are in a first switching position, which allows hydraulic oil to flow from the additional valve block 15 via the hydraulic line 18 to the attachment 14.

After an oil leakage has been detected by operating personnel or a sensor, the second emergency stop valves 24 in the boom assembly section of the hydraulic lines 18 are switched and closed by actuating the emergency stop actuator 25 and the 2-way valves 26 switch to a second switching position shown, in which hydraulic oil flows from the additional valve block 15 via the return line 27 into the hydraulic oil tank 16.

It is conceivable to use more than two emergency stop valves 23, 24 per hydraulic line 18.

In both versions of the hydraulic systems, one electrically and one hydraulically pilot-controlled, the detection of an oil leakage can be carried out by operating personnel or a sensor. The emergency stop actuator 25 can, for example, be provided as an actuation button in the driver's cab 5 or on the boom assembly 7 or be accessible via a controller of the mobile hydraulic construction machine 1, which includes the necessary operating elements to control the mobile hydraulic construction machine 1. By actuating the emergency stop actuator 25, the emergency stop valves 23, 24 are switched and the hydraulic oil flow is stopped. By actuating the emergency stop actuator 25 again, the emergency stop valves 23, 24 can be switched back and the hydraulic lines 18 to the attachment 14 can be opened again. The emergency stop valves 23, 24 are switched back when the oil leakage in the hydraulic lines 18 has been rectified. If the leakage is detected by a sensor, it is conceivable that an alarm is issued, whereupon the operating personnel can actuate the emergency stop actuator 25. However, it is also possible that the emergency stop valves 23, 24 and/or the additional valve block 15 are automatically activated by the sensor that detects a pressure drop. In a further example embodiment, it is intended to use emergency stop valves which close automatically in the event of a pressure drop in the hydraulic line 18.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A mobile hydraulic working machine, comprising:
an upper structure;
a lower structure;
a boom assembly with an arm, an attachment connected to the arm, and a hydraulic system to move the boom assembly and the attachment; wherein
the hydraulic system includes at least one hydraulic pump and a valve block to regulate flow through at least one hydraulic line connecting a hydraulic consumer to the at least one hydraulic pump to actuate the hydraulic consumer;
the at least one hydraulic line is connected to at least one emergency stop valve structured to close the hydraulic line in an emergency, the at least one emergency stop valve being arranged in the hydraulic line in a region of the boom assembly and/or in the upper structure on a flow side of the valve block remote from the pump.

2. The mobile hydraulic working machine according to claim 1, wherein the at least one hydraulic line is in a protected region on an upper side of the arm or is defined by channels, and the emergency stop valve is located in the protected region.

3. The mobile hydraulic working machine according to claim 1, wherein the at least one hydraulic line is attached at a first attachment point to the hydraulic consumer and at a second attachment point to the boom assembly and defines a flexible hose bend between the first and second attachment points, the at least one emergency stop valve being provided in the region of the boom assembly outside the flexible hose bend.

4. The mobile hydraulic working machine according to claim 1, wherein the at least one emergency stop valve is an electronically controlled solenoid valve.

5. The mobile hydraulic working machine according to claim 4, wherein the at least one emergency stop valve is a 2-way valve and the hydraulic system includes at least one return line which connects the at least one emergency stop valve to a hydraulic oil tank from which the hydraulic system is fed by the hydraulic pump.

6. The mobile hydraulic working machine according to claim 1, wherein the mobile hydraulic working machine includes an emergency stop actuator which communicates with the at least one emergency stop valve and/or the valve block and is operable to close when the at least one emergency stop valve is actuated.

7. The mobile hydraulic working machine according to claim 6, wherein the emergency stop actuator is located in a driver's cab of the mobile hydraulic working machine.

8. The mobile hydraulic working machine according to claim 1, wherein the at least one hydraulic line is connected to at least one sensor to detect a leakage in the at least one hydraulic line, the at least one sensor being capable of communicating with the at least one emergency stop valve and/or the valve block.

9. The mobile hydraulic working machine according to claim 1, wherein the mobile hydraulic working machine is a long-boom excavator having a reach height in a range from about 15 m to about 40 m.

10. A method for controlling a mobile hydraulic working machine including an upper structure, a lower structure, a boom assembly with an arm, an attachment connected to the arm and a hydraulic system to move the boom assembly and the attachment, the hydraulic system including at least one hydraulic pump and a valve block, and at least one hydraulic line connecting a hydraulic consumer to the hydraulic pump, the valve block being connected to the at least one hydraulic line, the method comprising:
detecting a leakage in the at least one hydraulic line between the hydraulic consumer and the valve block; and
switching at least one emergency stop valve located in a region of the boom assembly and/or in the upper structure on a flow side of the valve block remote from the pump in the at least one hydraulic line to shut off the at least one hydraulic line.

11. The method according to claim 10, wherein the at least one emergency stop valve is a 2-way valve and the hydraulic system includes at least one return line, and the emergency stop valve connects the associated hydraulic line to the return line, which is connected to a hydraulic oil tank from which the hydraulic system is fed by the hydraulic pump.

12. The method according to claim 10, further comprising actuating the valve block and shutting off the at least one hydraulic line after a predetermined time delay.

13. The method according to claim 10, wherein the detecting includes sighting by an operator or by a sensor in the hydraulic line.

14. The method according to claim 10, wherein the mobile hydraulic construction machine includes an emergency stop actuator communicating with the at least one emergency stop valve and/or the valve block, the method further comprising:
manually actuating the emergency stop device.
